(19) United States
(12) Patent Application Publication
(10) Pub. No.: US 2025/0296394 A1
(43) Pub. Date: Sep. 25, 2025

(54) DEVICE FOR MEASURING TYRE PRESSURE

(71) Applicant: SAFRAN ELECTRONICS & DEFENSE, PARIS (FR)

(72) Inventors: Sylvain PIETROPINTO, MOISSY-CRAMAYEL (FR); Gilles BIRABENT, MOISSY-CRAMAYEL (FR); Carlos TARECO, MOISSY-CRAMAYEL (FR); Antoine CASABIANCA, MOISSY-CRAMAYEL (FR)

(21) Appl. No.: 18/863,316

(22) PCT Filed: May 9, 2023
(86) PCT No.: PCT/EP2023/062243

§ 371 Date: Nov. 5, 2024

(30) Foreign Application Priority Data
May 12, 2022 (FR) FR2204539

(51) Int. Cl. B60C 23/04; B60C 29/00

(52) U.S. Cl. CPC B60C 23/0496; B60C 29/002; B60C 29/005; B60C 2200/02

(57) ABSTRACT

A device (100) for measuring the pressure of a tyre (2) mounted on a rim (1), comprising:
a valve (110) mounted on the rim (1) and comprising a first channel (112), a pin (115) mounted so as to be able to move in translation in the first channel between an open position and a closed position;
an intermediate body (120) mounted on the valve and that delimits a second channel (122) extending the first channel and receiving a fastening rod (130) for fastening the intermediate body to the valve, the fastening rod having a first end designed to move the pin from the closed position to the open position, and an intermediate portion closing the second channel;
a pressure sensor (140) received in a third channel of the intermediate body leading into the second channel; and
means (150) for retaining the pressure sensor in the third channel of the intermediate body.

The present invention relates to a device for measuring the pressure of a tyre of an aircraft wheel.

### BACKGROUND OF THE INVENTION

It is useful to know the pressure of the tyres fitted to the various wheels of an aircraft landing gear during different operating phases of the aircraft (phase of movement on the ground, approach phase prior to landing, for example) or in the context of maintenance operations.

To this end, the aircraft is conventionally equipped with a system for automatically monitoring the pressure inside the tyres of the wheels of the aircraft. The monitoring system is known as the TPMS or Tyre Pressure Monitoring System and comprises, for each wheel, a pressure sensor mounted on the rim of the wheel. The pressure sensor is coupled to an onboard data processing system and makes it possible to provide pilots with a real-time display, in the cockpit, of the tyre pressure during the different operating phases of the aircraft. During maintenance operations, operators can therefore view this display in order to obtain the desired information.

In reference to FIG. 1, the pressure sensor C is generally fitted to one end of a self-sealing valve V that is mounted on the rim G in order to allow the pressure sensor C to be removed without the loss of significant pressure from the tyre. The valve V is screwed into a bore that is in communication with the internal volume of the tyre through the rim G. The pressure sensor C is kept fitted in the valve V by means of a locking ring B screwed onto the valve V and a spring washer R compressed between a base of the locking ring B and one end of the pressure sensor C, helping to compensate for manufacturing clearances and limit the loosening of the locking ring B during operation. The pressure sensor C is powered and communicates with the data processing system by means of a cable H connecting said pressure sensor C with a rotating contact installed in the hub of the wheel.

The main disadvantage of arranging the pressure sensor C in this way lies in the fact that tightening the locking ring B tends to cause the pressure sensor C to rotate about its axis, thereby twisting the cable H, the service life of which may be limited as a result of the stress.

Furthermore, using a spring washer causes the locking ring B to jam, which tends to make maintenance difficult.

### OBJECT OF THE INVENTION

The aim of the invention is therefore to propose a device for measuring the pressure of a tyre that at least partially overcomes the abovementioned disadvantages.

### SUMMARY OF THE INVENTION

To this end, the invention proposes a device for measuring the pressure of a gas contained in a tyre mounted on a wheel rim, the device comprising:
a valve, suitable for being mounted on the rim, comprising a first gas flow channel, a pin mounted so as to be able to move in translation in the first channel between an open position in which the first channel is open and a closed position in which it is closed, and a return spring for returning the pin to the closed position;
an intermediate body that is mounted on the valve and that delimits a second channel extending the first channel and receiving a fastening rod for fastening the intermediate body to the valve, the fastening rod having a first end projecting into the first channel for moving the pin from the closed position to the open position, a second end that can be accessed from outside the second channel, and an intermediate portion closing the second channel;
a pressure sensor received in a third channel of the intermediate body, the third channel leading into the second channel between the first end and the intermediate portion of the fastening rod, being inclined in relation to the second channel; and
means for retaining the pressure sensor in the third channel of the intermediate body.

Therefore, the sensor may be mounted on the intermediate body when the latter is not yet fastened to the valve and may be brought into any orientation. The intermediate body is then fastened to the valve by means of the fastening rod, which performs three functions: fastening the intermediate body to the valve, closing the second channel and moving the pin instead of the sensor.

According to one particular feature, the device comprises means for indexing the intermediate body at an angle in relation to the valve.

In a particular manner, the angular indexing means comprise at least two studs carried by the valve and arranged to cooperate with holes provided in the intermediate body.

The means for indexing the intermediate body at an angle in relation to the valve make it possible to prevent said intermediate body from rotating in relation to said valve, and therefore to limit the stresses on the cable or cables extending out of the pressure sensor. They also make it possible to reproduce the angular position of the intermediate body in relation to the valve, thus ensuring that the sensor is correctly positioned in relation to the rim and making it easier to control.

In a particular manner, the studs and the holes are arranged to provide the intermediate body with at least two possible angular positions in relation to the valve.

In a particular manner, the first end of the fastening rod comprises a piercing forming a fourth gas flow channel.

According to another particular feature, the first end of the fastening rod comprises a thread engaged in a tapped hole of the first channel.

According to another particular feature, the retaining means comprise a locking ring arranged to be fastened on the intermediate body, trapping the pressure sensor in the third channel.

The invention also relates to an aircraft wheel comprising a rim on which a tyre is mounted and such a device.

The invention also relates to an aircraft landing gear comprising at least one such wheel.

The invention further relates to an aircraft comprising at least one such landing gear.

### BRIEF DESCRIPTION OF THE DRAWINGS

The invention will be better understood in the light of the following description, which is purely illustrative and non-limiting, and should be read with reference to the accompanying drawings, in which:

FIG. 1 is an axial cross-sectional view of a device for measuring the pressure of a tyre of an aircraft wheel according to the prior art;

FIG. 2 is a simplified representation of an aircraft comprising main landing gears having wheels equipped with the pressure measuring device according to the invention;

FIG. 3 is an axial cross-sectional view of one of the wheels of the aircraft shown in FIG. 2;

FIG. 4 is a perspective view of the measurement device shown schematically in FIG. 3;

FIG. 5 is a partial view of the measurement device shown in FIG. 4;

FIG. 6 is an axial cross-sectional view of the measurement device shown in FIG. 4; and

FIG. 7 is a perspective view of a variant of the valve of the measurement device shown in FIG. 4.

### DETAILED DESCRIPTION OF THE INVENTION

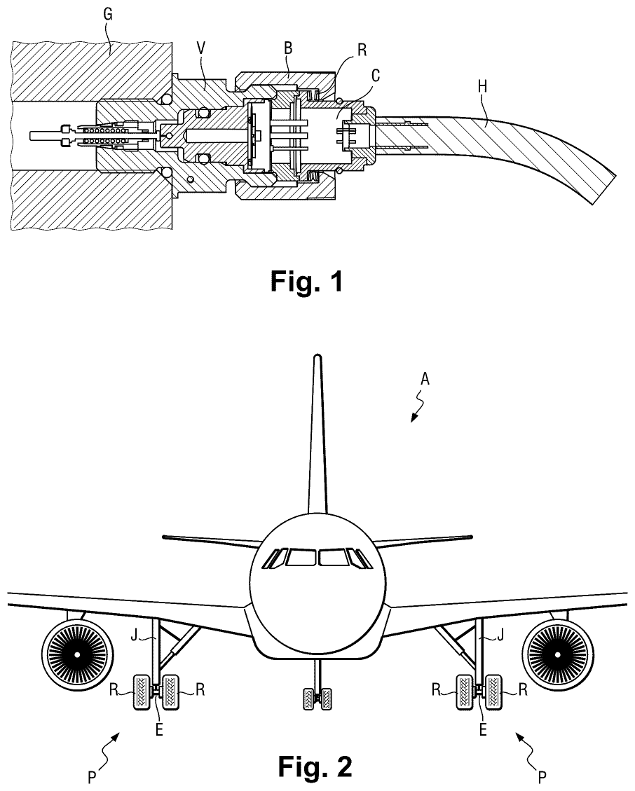

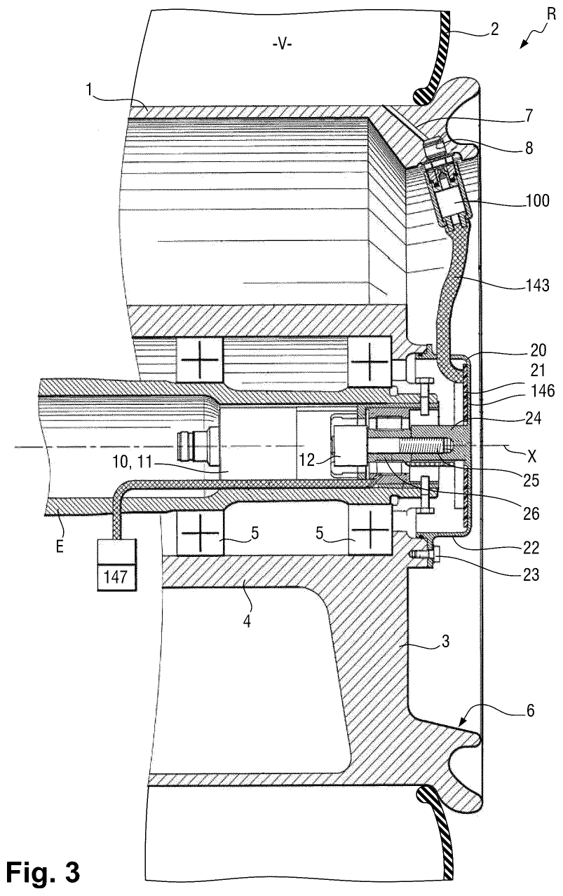

In reference to FIG. 2, the invention applies to an aircraft A comprising main landing gears P each comprising a leg J having a first end hinged to a structure of the aircraft A and a second end provided with an axle E. Each axle E is provided, as shown in FIG. 3, with a wheel R comprising an annular rim 1 on which a tyre 2 is mounted. In a manner that is known, the tyre 2 and the rim 1 together delimit a volume V in which a gas is trapped. The rim 1 is connected by a web 3 to a hub 4 mounted so as to rotate, about an axis X, on a free end of the axle E, by means of bearings 5.

Inside a free end of the axle E, a tachometer 10 is arranged, being intended to monitor the rotation of the wheel 1. The tachometer 10 comprises a fixed part 11 secured to the axle E, and a movable part 12 that is able to rotate substantially about the axis X in relation to the fixed part 11.

A cap 20 forming a cover is fitted to the rim 1 along the axis X. The cap 20 comprises a base 21 surrounded by a cylindrical side wall 22. The side wall 22 comprises an outer peripheral flange bearing against the rim 1, via which the cap 20 is fastened to the rim 1 by means of screws 23, such that said cap 20 is constrained to rotate with the wheel 1.

The cap 20 further comprises a bushing 24 that extends substantially along the axis X, protruding from the cover 21 towards the inside of the axle E. The bushing 24 has a splined central hole receiving a splined rod 25 extending axially from the bushing 24. The free end of the rod 25 is arranged to be linked to the movable part 12 of the tachometer 10 by means of a rotary coupling mechanism 26 designed to compensate for an axial offset between the axis of rotation of the movable part 12 of the tachometer 10 and the axis of rotation of the rod 25, and therefore of the cap 20. The coupling mechanism 26 is, for example, a rubber buffer secured to the movable part 12 of the tachometer 10 and to the splined rod 25.

The rim 1 comprises a substantially frustoconical internal surface 6 that extends from the web 3 towards a distal end of the rim 1. A pressure measurement channel 7 extends into the rim 1 in a plane passing through the axis X of rotation of the wheel. The channel 7 is in this instance substantially straight and comprises a first end leading into the volume V and a second end leading to the internal surface 6. The second end of the channel 7 comprises an internally threaded bore 8 via which a device 100 is fastened for measuring the pressure of the gas trapped in the volume V delimited by the rim 1 and the tyre 2.

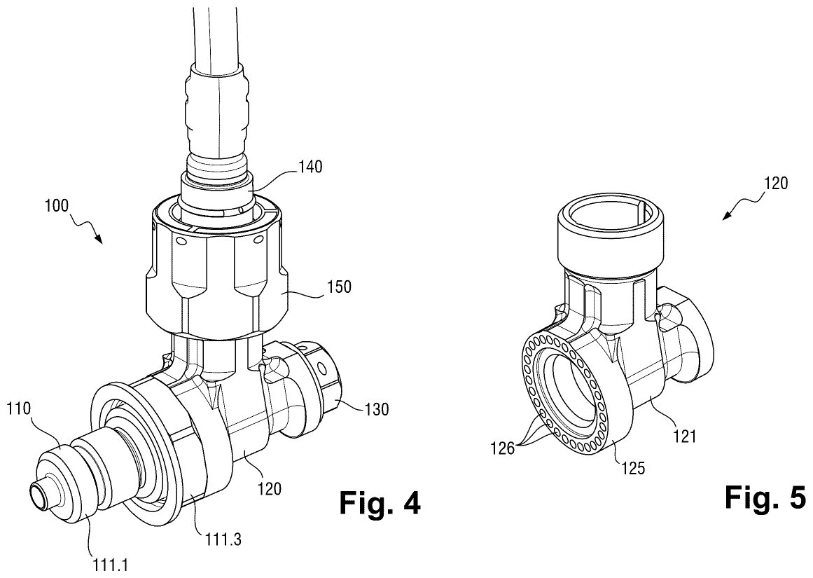

In reference to FIG. 4, the device 100 comprises a self-sealing valve 110 screwed into the bore 8 in the rim 1, an intermediate sensor support body 120 engaged on the valve 110 and kept in position on said valve 110 by means of a fastening rod 130 screwed into the valve 110, and a pressure sensor 140 mounted in the sensor support 120 and kept in position in the sensor support 120 by means of a locking ring 150 screwed onto the sensor support 120.

In reference to FIG. 6, the valve 110 comprises a generally tubular body 111 that delimits a channel 112 for the gas stored in the volume V to pass through. The body 111 extends along an axis X₁₁₀ and comprises a first section 111.1 for connection to the rim 1 and a second section 111.2 for connection with the sensor support 120. The first and second sections 111.1, 111.2 are separated by an outer flange 111.3 that has a first face transverse to the axis X₁₁₀ forming an abutment when the valve 110 is screwed into the bore 8 in the rim 1 and, on the opposite side, a second face transverse to the axis X₁₁₀ forming an abutment when engaging the sensor support 120 on the second section 111.2 of the body 111 along the axis X₁₁₀.

The first section 111.1 of the body 111 is provided on the outside with a thread arranged to cooperate with the thread of the bore 8 in the rim 1 so as to allow the valve 110 to be screwed onto the rim 1. The first section 111.1 is also provided on the outside with a first annular groove provided between the flange 111.3 and the thread of said first section 111.1. The first groove receives a first annular seal 113 intended to provide a tight seal between the first section 111.1 of the body 111 and the bore 8 in the rim 1.

The first section 111.1 of the body 111 delimits a first end portion of the channel 112 inside which a valve mechanism 114 is housed, allowing the gas trapped in the volume V to flow through the channel 112 or preventing it from doing so. The valve mechanism 114 comprises a pin 115 (or poppet) mounted so as to be able to move in translation, substantially along the axis X₁₁₀, between an open position in which it is offset from a seat and allows the gas trapped in the volume V to flow through the channel 112, and a closed position in which it bears against a seat and prevents said gas from flowing through said channel 112. A spring 116 returns the pin 115 towards its closed position and a safety vent is provided at the thread of the first section 111.1, leading into the valve mechanism 114 so as to allow gas to escape from the volume V when an operator unscrews the valve 110 while the gas is still under pressure. As the valve mechanism 114 is well known from the prior art, it shall not be described in further detail here.

The second section 111.2 of the body 111 is provided on the outside with a second annular groove provided at a free end of said second section 111.2. The second groove receives a second annular seal 117 intended to provide a tight seal between the second section 111.2 of the body 111 and the sensor support 120.

The second section 111.2 delimits a second end portion of the channel 112, part of the inside of which is threaded and into which the fastening rod 130 is screwed.

The flange 111.3 has, along the axis X₁₁₀, a generally hexagonal cross section, and comprises two cylindrical holes 118 with an axis parallel to the axis X₁₁₀ and which emerge onto the second transverse face of the flange 111.3 facing the sensor support 120. The holes 118 are identical and diametrically opposite each other in relation to the axis X₁₁₀. Each of the holes 118 receives an anti-rotation stud 119 protruding from the flange 111.3. The studs 119 are in this instance identical and have a diameter that is slightly greater than that of the holes 118, meaning that said studs 119 are force fitted into said holes 118.

The sensor support 120 comprises a main body portion 121 that is generally tubular and that extends substantially coaxially to the valve 110 along an axis X₁₂₀ that substantially coincides with the axis X₁₁₀. The main body portion 121 delimits a channel 122 that has a first end comprising a first bore 123 shaped to receive the second section 111.2 of the valve body 111, and a second end, opposite the first end, comprising a second bore 124 shaped to receive a portion of the fastening rod 130. A central portion of the channel 122 provides fluidic communication between the first bore 123 and the second bore 124, and comprises a thread into which the fastening rod 130 can be screwed in such a way that said fastening rod 130 extends through the central portion and remains fastened to the sensor support 120 when it is unscrewed from the valve body 111 (preventing the fastening rod 130 from being lost).

The internal diameter of the first bore 123 is slightly greater than an external diameter of the second section 111.2 of the valve body 111, so as to allow the sensor support 120 to be fitted onto said second section 111.2, the second seal 117 being intended to provide a tight seal between said second section 111.2 and said first bore 123.

The end of the main body portion 121 facing the flange 111.3 of the valve body 111 comprises an outer collar 125 having a lateral face forming an abutment when the sensor support 120 is fitted onto the second section 111.2 of the valve body 111.

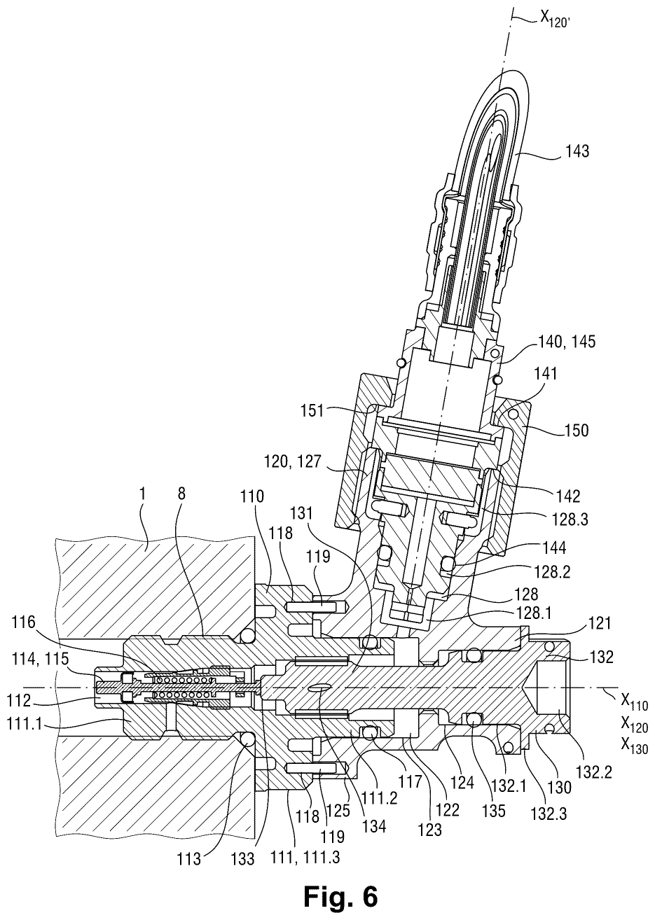

In reference to FIG. 5, the collar 125 comprises a plurality of identical holes 126 arranged to cooperate in pairs with the studs 119 carried by the valve body 111. The holes 126 are cylindrical and have an axis parallel to the axis X₁₂₀ and emerge on the lateral face of the collar 125 facing the flange 111.3 of the valve body 111. The holes 126 are distributed symmetrically around the axis X₁₁₀, next to an outer periphery of the collar 125, and have a diameter slightly greater than that of the studs 119. The centres of the holes 126 lie on the same circle, the centre of which is located on the axis X₁₂₀, the holes 126 being diametrically opposite each other in pairs. The studs 119 and the holes 126 thus form means for indexing the sensor support 120 at an angle on the valve body 111, and also means for preventing said sensor support 120 from rotating about the axis X₁₁₀ in relation to the valve body 111. It should be noted, in particular, that the holes 126 make it possible for the sensor support 120 to occupy a plurality of possible angular positions around the axis X₁₁₀ in relation to valve body 111.

The sensor support 120 is kept fitted onto the valve body 111 via the fastening rod 130, which is generally cylindrical and which extends along an axis X₁₃₀ that substantially coincides with the axis X₁₂₀, passing all the way through the main body portion 121 of said sensor support 120.

The fastening rod 130 comprises:
a first end 131 provided on the outside with a thread arranged to cooperate with the thread of the central portion of the channel 122 of the sensor support 120 and the thread inside the second section 111.2 of the valve body 111;
a second end 132 that protrudes from the main body portion 121; and
an intermediate portion 132.1 arranged in the vicinity of the second end 132 in order to close the second bore 124 of the sensor support 120.

The first end 131 of the fastening rod 130 comprises a front face 133 arranged to come to bear against an end of the pin 115 and to bring said pin 115 from the closed position to the open position when the fastening rod 130 is screwed into the valve body 111. The first end 131 of the fastening rod 130 also comprises a piercing that lies in a plane passing through the axis X₁₃₀ and emerges to either side of the thread of the fastening rod 130, forming a channel 134 that provides fluidic communication between the channel 112 of the valve body 111 and the channel 122 of the sensor support 120, and thus allowing the gas trapped in the volume V to pass through the valve body 111 and reach the first bore 123 of the sensor support 120. The channel 134 is in this instance straight and extends along an axis which is oblique with respect to the axis X₁₃₀.

The second end 132 of the fastening rod 130 is provided with a cavity 132.2 for cooperating with a tool used to rotate the fastening rod 130 about its axis X₁₃₀ and comprises a base 132.3 forming an abutment when screwing the fastening rod 130 into the valve body 111. The base 132.3 separates the second end 132 from the cylindrical intermediate portion 132.1 received in the second bore 124 of the main body portion 121 of the sensor support 120. The intermediate portion 132.1 is provided on the outside with an annular groove that receives an annular seal 135 intended to provide a tight seal between said intermediate portion 132.1 and the second bore 124 of the sensor support 120.

The sensor support 120 further comprises a generally tubular secondary body portion 127 that protrudes from the main body portion 121 along an axis X_{120′} that is oblique with respect to the axis X₁₂₀. The secondary body portion 127 delimits a channel 128 having a first end leading to the outside of the sensor support 120 and a second end, opposite the first end, leading into the channel 122 of the main body portion 121 between the seal 117 and a base of the first bore 123 of said main body portion 121. The channel 128 is staged and thus comprises three successive bores 128.1, 128.2, 128.3 forming a housing in which the pressure sensor 140 is fitted: the first bore 128.1 leads to the outside of the sensor support 120, the second bore 128.2 leads to the first bore 128.1 and has a diameter larger than that of said first bore 128.1, and the third bore 128.3 leads to the second bore 128.2 and has a diameter larger than that of said second bore 128.2.

The pressure sensor 140 is generally cylindrical and extends at the end of a cable 143 projecting from the cap 20. The pressure sensor 140 is secured in a sealed manner in the secondary body portion 127 of the sensor support 120 by means of the locking ring 150 and a seal 144 carried by said pressure sensor 140. The locking ring 150 is screwed onto an external thread provided at a free end of the secondary body portion 127 of the sensor support 120, and comprises an inner shoulder 151 arranged to cooperate with a first outer shoulder 141 of the pressure sensor 140 so as to bring a second outer shoulder 142 of said pressure sensor 140 into abutment against said free end of the secondary body portion 127. The seal 144 provides a tight seal between the pressure sensor 140 and the second bore 128.2 of the secondary body portion 127 of the sensor support 120.

The pressure sensor 140 is in this instance of the piezoelectric type and comprises a pressure probe 145 designed to measure a pressure lying within the useful range of pressures inside the tyres. The pressure probe 145 is connected, via the cable 143, to a module 146 for processing the signal and controlling the pressure probe 145. The module 146 comprises a printed circuit arranged on the base 21 of the cap 20, around the bushing 24.

A processing unit 147 is secured to a fixed part of the landing gear or to the body of the aircraft, and is capable of using and, in particular, displaying the pressure measurements taken using the pressure sensor 140. The module 146 and the processing unit 147 are connected to each other by communication means (not shown) that are suitable for establishing radio frequency transmission, i.e., transmission by hertzian means, between said module 146 and said processing unit 147. This transmission is bi-directional transmission, i.e., each entity can send and receive information. The communication means are also capable of transmitting, by hertzian means, the electrical energy needed in order for the pressure sensor 140 to operate.

The sensor support 120, the sensor 140 and the locking ring 150 thus form an assembly that can be removed from the valve 110 simply by unscrewing and withdrawing the fastening rod 130. Unscrewing the fastening rod 130 causes the pin 115 of the valve 110 to shift from the open position to the closed position (before the thread of the fastening rod 130 is totally disengaged from the tapped hole), allowing the assembly formed by the sensor support 120, the sensor 140 and the locking ring 150 to be removed without this removal causing the tyre 2 to deflate. It is then not necessary to unscrew the locking ring 150 during a maintenance operation.

The studs 119 carried by the valve 110 and the holes 126 provided in the sensor support 120 make it possible to:
position the sensor support 120 (and therefore the sensor 140) at an angle with respect to the valve 110 along the axis X₁₀₀, the holes 126 offering several possible angular positions; and
constrain the valve 110 and the sensor support 120 in rotation in such a way as to prevent said valve support 120 (and therefore the sensor 140) from rotating in relation to said valve 110 about the axis X₁₀₀, X₁₂₀.

Using a safety wire safety device and determining a tightening torque for the fastening rod 130 and the locking ring 150 allows better control and reproducibility of the assembly of the device 100.

Naturally, the invention is not limited to the embodiment described, but covers any variant coming within the ambit of the invention as defined by the claims.

Although the device 100 applies in this instance to the wheels R equipping the main landing gears P, it may also be applied to the wheels equipping the front landing gear of the aircraft A shown in FIG. 1, and more generally any wheel equipping a landing gear.

Although the device 100 applies in this instance to an aircraft wheel, it may more generally be applied to any vehicle equipped with a wheel provided with a tyre trapping a gas.

There may be more than two studs 119. Preferably, the studs 119 are distributed evenly around the axis X₁₁₀.

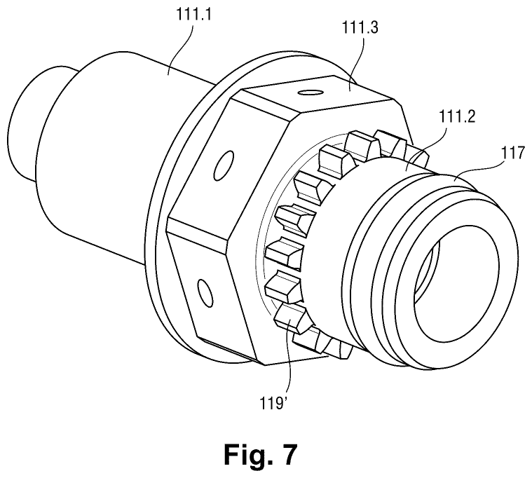

The studs 119 and the holes 126 may be replaced by any other angular indexing means allowing the sensor support 120 to be positioned at an angle in relation to the valve 110. For example, the second section 111.2 of the valve body 111 may comprise, as shown in FIG. 7, an externally toothed ring 119′ designed to cooperate with an internally toothed ring received in the first bore 123 of the sensor support 120.

Although the secondary body portion 127 of the sensor support 120 extends in this instance obliquely with respect to the main body portion 121 of said sensor support 120, it may also extend in a perpendicular direction. Irrespective of whether the secondary body portion 127 extends in an oblique or perpendicular direction with respect to the main body portion 121, said secondary body portion 127 is in this instance considered to be inclined with respect to said main body portion 121.

1. A device for measuring the pressure of a gas contained in a tyre mounted on a rim of a wheel, the device comprising:
a valve, suitable for being mounted on the rim, comprising a first gas flow channel, a pin mounted so as to be able to move in translation in the first channel between a position in which the first channel is open and a position in which it is closed, and a spring for returning the pin to the closed position;
an intermediate body that is mounted on the valve and that delimits a second channel extending the first channel and receiving a fastening rod for fastening the intermediate body to the valve, the fastening rod having a first end projecting into the first channel for moving the pin from the closed position to the open position, a second end that can be accessed from outside the second channel, and an intermediate portion closing the second channel;
a pressure sensor received in a third channel of the intermediate body, the third channel leading into the second channel between the first end and the intermediate portion of the fastening rod, being inclined in relation to the second channel; and
means for retaining the pressure sensor in the third channel of the intermediate body.

2. The device according to claim 1, comprising means for indexing the intermediate body at an angle in relation to the valve.

3. The device according to claim 2, wherein the angular indexing means comprise at least two studs carried by the valve and arranged to cooperate with holes provided in the intermediate body.

4. The device according to claim 3, wherein the studs and the holes are arranged to provide the intermediate body with at least two possible angular positions in relation to the valve.

5. The device according to claim 1, wherein the first end of the fastening rod comprises a piercing forming a fourth gas flow channel.

6. The device according to claim 1, wherein the first end of the fastening rod comprises a thread engaged in a tapped hole of the first channel.

7. The device according to claim 1, wherein the retaining means comprise a locking ring arranged to be fastened on the intermediate body, trapping the pressure sensor in the third channel.

8. An aircraft wheel, comprising:
a rim on which a tyre is mounted; and
a device according to claim 1.

9. An aircraft landing gear, comprising at least one wheel according to claim 8.

10. An aircraft, comprising at least one landing gear according to claim 9.
